(19) United States
(12) Patent Application Publication
(10) Pub. No.: US 2003/0123370 A1
(43) Pub. Date: Jul. 3, 2003

(54) Magneto-optical recording and reproducing apparatus

(75) Inventors: Yoshihiro Nakao, Kawasaki (JP); Haruhiko Izumi, Kawasaki (JP)

Correspondence Address: Patrick G. Burns, GREER, BURNS & CRAIN, LTD., Suite 2500, 300 South Wacker Dr., Chicago, IL, 60606, US

(73) Assignee: FUJITSU LIMITED

(21) Appl. No.: 10/097,808

(22) Filed: Mar. 14, 2002

(30) Foreign Application Priority Data
Dec. 28, 2001 (JP) 2001-402010

(51) Int. Cl. G11B 7/135

(52) U.S. Cl. 369/112.17

(57) ABSTRACT

The magneto-optical recording and reproducing apparatus comprises a laser source, a collimator lens, an objective lens, a magneto-optical recording medium, a servo signal detector, a reproduction signal detector, a signal separating polarization beam splitter, a data recording polarization beam splitter and a data reproducing polarization beam splitter. The data recording polarization beam splitter and the data reproducing polarization beam splitter are disposed on a rotatable PBS holder so that the positions of the beam splitters can be changed according to whether the apparatus is for reproducing data or for recording data. With the apparatus, the quantity of light emitted from the laser source can be reduced since the optical path efficiency of the laser beam to the medium is enhanced at the time of recording, and carrier-output/noise ratio C/N can be increased at the time of reproducing.

### BACKGROUND OF THE INVENTION

1. Field of the Invention

The present invention relates to a magneto-optical recording and reproducing apparatus.

2. Description of Related Art

FIG. 1 is a schematic illustration showing a main part of a conventional magneto-optical recording and reproducing apparatus. The main part of the magneto-optical recording and reproducing apparatus consists of a laser source LD, a collimator lens CL, a polarization beam splitter (hereinafter referred to as “a PBS”) 1, an actuator ACT having an objective lens OB thereon, a signal separating polarization beam splitter (hereinafter referred to as “a signal separating PBS”) 2, a servo signal detector 11 and a reproduction signal detector 13. For operation, a magneto-optical recording medium DISK is set in the magneto-optical recording and reproducing apparatus. A laser diode is generally employed as the laser source LD, selected in view of the power consumption, shape, wavelength and the like. The collimator lens CL transforms a laser beam emitted from the laser source LD into a parallel beam. The PBS 1 separates an optical path of a laser beam to the medium DISK from an optical path of a laser beam from the medium DISK, by transmitting a laser beam to the objective lens OB as well as reflecting the beam reflected at the objective lens OB to the signal separating PBS 2. The actuator ACT condenses the beam onto the magneto-optical recording medium DISK by the action of the objective lens OB placed thereon, to record data onto the magneto-optical medium DISK or to reproduce data on the medium DISK. The signal separating PBS 2 reflects and transmits the beam reflected at the PBS 1. By reflecting and transmitting the beam with the signal separating PBS 2, the reflected beam is separated into a reflected beam for detecting a servo signal (hereinafter referred to as “a servo signal reflected beam”) 10 and a reflected beam for detecting a reproduction signal (hereinafter referred to as “a reproduction signal reflected beam”) 12. The servo signal reflected beam 10 and the reproduction signal reflected beam 12 are respectively guided to the servo signal detector 11 and the reproduction signal detector 13. The servo signal detector 11 transforms the detected servo signal reflected beam 10 into an electric signal. The reproduction signal detector 13 transforms the detected reproduction signal reflected beam 12 into an electric signal.

For recording data, an optical path for recording data is formed by the laser source LD, the collimator lens CL, the PBS 1 and the objective lens OB. A laser beam is guided onto the magneto-optical recording medium DISK to record data. For focusing and tracking the magneto-optical recording medium DISK, a beam reflected at the magneto-optical recording medium DISK is guided to the servo signal detector 11 as a servo signal reflected beam 10, through the PBS 1 and the signal separating PBS 2.

For reproducing data, an optical path for reproducing data is formed by the laser source LD, the collimator lens CL, the PBS 1, the objective lens OB, the magneto-optical recording medium DISK, the PBS 1 and the signal separating PBS 2. A beam reflected at the magneto-optical recording medium DISK is separated, and guided by the signal separating PBS 2, into a servo signal reflected beam 10 and a reproduction signal reflected beam 12 to reproduce data. The servo signal reflected beam 10 is detected by the servo signal detector 11. The reproduction signal reflected beam 12 is detected by the reproduction signal detector 13. The action of the servo signal reflected beam 10 and the servo signal detector 11 are the same as that for recording data.

The reproduction signal detector 13 separates the reproduction signal reflected beam 12 reflected at the magneto-optical recording medium DISK into a P polarization component and an S polarization component. Each polarization component is detected as an electric signal by two photo detectors (PDs) which are not shown in the figure. The reproduction signal detector 13 generates electric reproduction signals by differentiating the two photo detectors (PDs). In a conventional magneto-optical recording and reproducing apparatus, the mutual positional relation in the optical system is fixed irrespective of whether the apparatus is recording data or reproducing data, and is never changed during the operation thereof.

In conventional magneto-optical recording and reproducing apparatuses, the transmittance of the PBS 1 is required to be large to ensure intensity of light at the magneto-optical recording medium DISK at the time of data recording. However, when the P polarization transmittance Tp of the PBS 1 is increased, the P polarization reflectance Rp is decreased since the P polarization transmittance Tp and the P polarization reflectance Rp have the following relation:

Rp=1−Tp.

The decrease of the P polarization reflectance Rp of the PBS 1 causes a decrease of the quantity of the reflected P polarization beam. When the quantity of the P polarization beam reflected at the PBS 1 for separating an optical path of a laser beam to the medium DISK from an optical path of a laser beam from the medium DISK is decreased, the reproduction signal reflected beam 12 becomes weak. When the reproduction signal reflected beam 12 becomes weak, the ratio of a carrier output (C) to a noise (N) of the reproduction signal reflected beam 12, or the carrier-output/noise ratio C/N, is decreased as explained hereinafter.

On one hand, quantities of light Pa and Pb detected by the two photo detectors (PDs) of the reproduction signal detector 13 which are not shown in the figure, or a bisected PD for reproduction, can be respectively expressed by the following equation (1):

$$[ \begin{matrix}P a \\ Pb\end{matrix} ] = K \cdot P \cdot [ \begin{matrix}Rp \cdot {cos}^{2} θ k + 2 \sqrt{Rp} cos θ k \cdot sin θ k + {sin}^{2} θ k \\ Rp \cdot {cos}^{2} θ k - 2 \sqrt{Rp} cos θ k \cdot sin θ k + {sin}^{2} θ k\end{matrix} ] \qquad ( 1 )$$

where K is a constant, P is a quantity of light reflected at the medium, Rp is the P polarization reflectance of optical system components and θk is a Kerr rotational angle.

Based on the figure (1), the carrier output C, which is proportional to the difference between the quantities of light Pa and Pb detected by the bisected PD for reproduction, can be expressed by the following equation:

C∝Pa−Pb=2KP\sqrt{Rp} sin 2θk ∝\sqrt{Rp}

The above equation indicates that the carrier output C is proportional to the square root of the P polarization reflectance Rp.

On the other hand, a medium noise Nd of the magneto-optical recording medium DISK and a light source noise Nld of the laser source LD are composed of a noise due to variance of quantity of light and a noise due to polarization. The medium noise Nd and the light source noise Nld, which are proportional to the difference between the quantities of light Pa and Pb detected by the bisected PD for reproduction like the carrier output C, can be expressed by the following equation:

Nd,Nld∝Pa−Pb∝\sqrt{Rp}

The above equation indicates that the medium noise Nd and the light source noise Nld are proportional to the square root of the P polarization reflectance Rp.

A shot noise Ns at the photo detector (PD) of the reproduction signal detector 13, which is proportional to the square root of photocurrent generated by received light, can be expressed by the following equation:

$$\begin{matrix}NS ∝ \sqrt{{( \sqrt{Ia} )}^{2} + {( \sqrt{Ib} )}^{2}} = \sqrt{Ia + Ib} ∝ \sqrt{P a + Pb} \\ = \sqrt{2 KP ( Rp \cdot {cos}^{2} θ k + {sin}^{2} θ k )} \\ ≅ \sqrt{2 KPRp \cdot {cos}^{2} θ k} ∝ \sqrt{Rp}\end{matrix}$$

where

Rp·cos² θk>>sin² θk

since θk is smaller than 1°. The above equations indicates that the shot noise Ns is proportional to the square root of the P polarization reflectance Rp.

A circuit noise Nc is constant irrespective of the quantities of an emitted beam and a received beam. On one hand, the total noise N of the magneto-optical recording and reproducing apparatus is expressed by the sum of the squares of the four noises: the medium noise Nd, the light source noise Nld, the shot noise Ns and the circuit noise Nc. The medium noise Nd, the light source noise Nld and the shot noise Ns are values proportional to the square root of the P polarization reflectance Rp. The circuit noise Nc is a constant value. On the other hand, the carrier output C is proportional to the square of the P polarization reflectance Rp. Consequently, when the P polarization reflectance Rp is decreased, and thus, the quantity of reflected light is decreased, the decrease of the total noise N of the magneto-optical recording and reproducing apparatus is smaller than the decrease of the carrier output C of reproduction signals. As a result, the carrier-output/noise ratio C/N is decreased.

As described above, in the conventional magneto-optical recording and reproducing apparatus, when the reflectance of the PBS 1 is set large to ensure intensity of light at the magneto-optical recording medium DISK at the time of data recording, the quantity of the P polarization beam reflected at the PBS 1 is decreased. In such a case, there arises a decrease of the quantity of the reproduction signal reflected beam 12, i.e. a decrease of the carrier output C. As a result, the carrier-output/noise ratio C/N is decreased since the decrease of the total noise N of the magneto-optical recording and reproducing apparatus is smaller than the decrease of the carrier output C corresponding to the reproduction signal reflected beam 12.

### BRIEF SUMMARY OF THE INVENTION

The present invention has been made with the aim of solving the above problem, and an object thereof is to provide a magneto-optical recording and reproducing apparatus with which an optical path efficiency of a beam, or a laser beam, to the medium (=the quantity of light at a light-condensed point on the magneto-optical recording medium/the quantity of light emitted from the laser source) can be enhanced so that the quantity of light emitted from the laser source can be reduced at the time of data recording, and the carrier-output/noise ratio C/N can be increased at the time of data reproducing.

Each of the magneto-optical recording and reproducing apparatuses according to the present invention comprises: a light source for generating a beam for irradiating a magneto-optical recording medium; an optical path formed between the magneto-optical recording medium and the light source; a servo signal detector for detecting a beam reflected at the magneto-optical recording medium as a servo signal to perform focusing and tracking of the beam; and a reproduction signal detector for detecting the beam reflected at the magneto-optical recording medium as a reproduction signal.

One magneto-optical recording and reproducing apparatus according to the present invention further comprises: a separating polarization beam splitter for separating the beam reflected at the magneto-optical recording medium into a reproduction signal reflected beam and a servo signal reflected beam; a recording polarization beam splitter disposed on the optical path at the time of data recording for guiding the beam reflected at the magneto-optical recording medium to the separating polarization beam splitter; a reproducing polarization beam splitter disposed on the optical path at the time of data reproducing for guiding the beam reflected at the magneto-optical recording medium to the separating polarization beam splitter; and a beam splitter displacing unit for displacing the recording polarization beam splitter and the reproducing polarization beam splitter.

Another magneto-optical recording and reproducing apparatus according to the present invention further comprises: a recording polarization beam splitter disposed on the optical path at the time of data recording for guiding the beam reflected at the magneto-optical recording medium as a servo signal reflected beam; a reproducing polarization beam splitter disposed on the optical path at the time of data reproducing for guiding the beam reflected at the magneto-optical recording medium to the recording polarization beam splitter; and a beam splitter displacing unit for displacing the recording polarization beam splitter and the reproducing polarization beam splitter.

The magneto-optical recording and reproducing apparatus may further comprise a reflecting mirror for guiding the reflected beam guided from the recording polarization beam splitter to the servo signal detector as a servo signal reflected beam at the time of data recording.

Another magneto-optical recording and reproducing apparatus according to the present invention further comprises: a recording polarization beam splitter disposed on the optical path at the time of data recording for guiding the beam reflected at the magneto-optical recording medium as a servo signal reflected beam; a reproducing polarization beam splitter disposed on the optical path at the time of data reproducing for guiding the beam reflected at the magneto-optical recording medium as a reproduction signal reflected beam; a reflecting polarization beam splitter for guiding the beam reflected at the magneto-optical recording medium to the recording polarization beam splitter through the reproducing polarization beam splitter at the time of data reproducing; and a beam splitter displacing unit for displacing the recording polarization beam splitter, the reproducing polarization beam splitter and the reflecting polarization beam splitter.

Another magneto-optical reproducing apparatus according to the present invention further comprises: a recording polarization beam splitter disposed on the optical path for guiding the beam reflected at the magneto-optical recording medium as a servo signal reflected beam; a reproducing polarization beam splitter disposed on the optical path at the time of data reproducing for guiding the beam reflected at the magneto-optical recording medium as a reproduction signal reflected beam; and a beam splitter displacing unit for displacing the reproducing polarization beam splitter.

In the magneto-optical recording and reproducing apparatuses, the transmittance of the recording polarization beam splitter can be larger than the transmittance of the reproducing polarization beam splitter.

In each of the magneto-optical recording and reproducing apparatuses above, a polarization beam splitter used for recording data and a polarization beam splitter used for reproducing data can be different beam splitters. Used for recording data is a polarization beam splitter with high P polarization transmittance. Used for reproducing data is a polarization beam splitter with low P polarization transmittance. In recording data, an optical path efficiency of a beam, or a laser beam, to the medium (=the quantity of light at a light-condensed point on the magneto-optical recording medium/the quantity of light emitted from the laser source) can be enhanced. The enhancement of the optical path efficiency of a laser beam to the medium allows the quantity of light emitted from the laser source to be reduced so that the power consumption of the laser source can be lowered and the life of the laser source can be elongated. For reproducing data, the carrier-output/noise ratio C/N can be increased.

Furthermore, as the transmittance of the recording polarization beam splitter is set larger than that of the reproducing polarization beam splitter, the quantity of light emitted from the laser source for recording data can be surely reduced, and the carrier-output/noise ratio C/N at the time of data reproducing can be surely increased.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic illustration showing a main part of a conventional magneto-optical recording and reproducing apparatus;

FIGS. 2A and 2B are block diagrams showing a main part of a magneto-optical recording and reproducing apparatus according to Embodiment 1 of the present invention;

FIGS. 3A and 3B are block diagrams showing a main part of a magneto-optical recording and reproducing apparatus according to Embodiment 2 of the present invention;

FIGS. 4A and 4B are block diagrams showing a main part of a magneto-optical recording and reproducing apparatus according to Embodiment 3 of the present invention;

FIGS. 5A and 5B are block diagrams showing a main part of a magneto-optical recording and reproducing apparatus according to Embodiment 4 of the present invention;

FIGS. 6A and 6B are block diagrams showing a main part of a magneto-optical recording and reproducing apparatus according to Embodiment 5 of the present invention; and

FIG. 7 is a graph showing an example where the transmittance of the polarization beam splitters of Embodiment 2 is changed.

### DETAILED DESCRIPTION OF THE INVENTION

The following description will explain a magneto-optical recording and reproducing apparatus according to the present invention in detail with reference to the drawings illustrating some embodiments thereof.

Embodiment 1

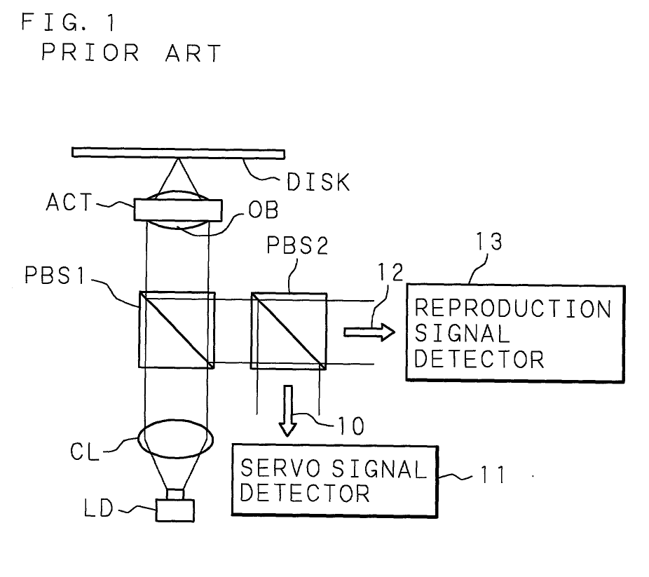

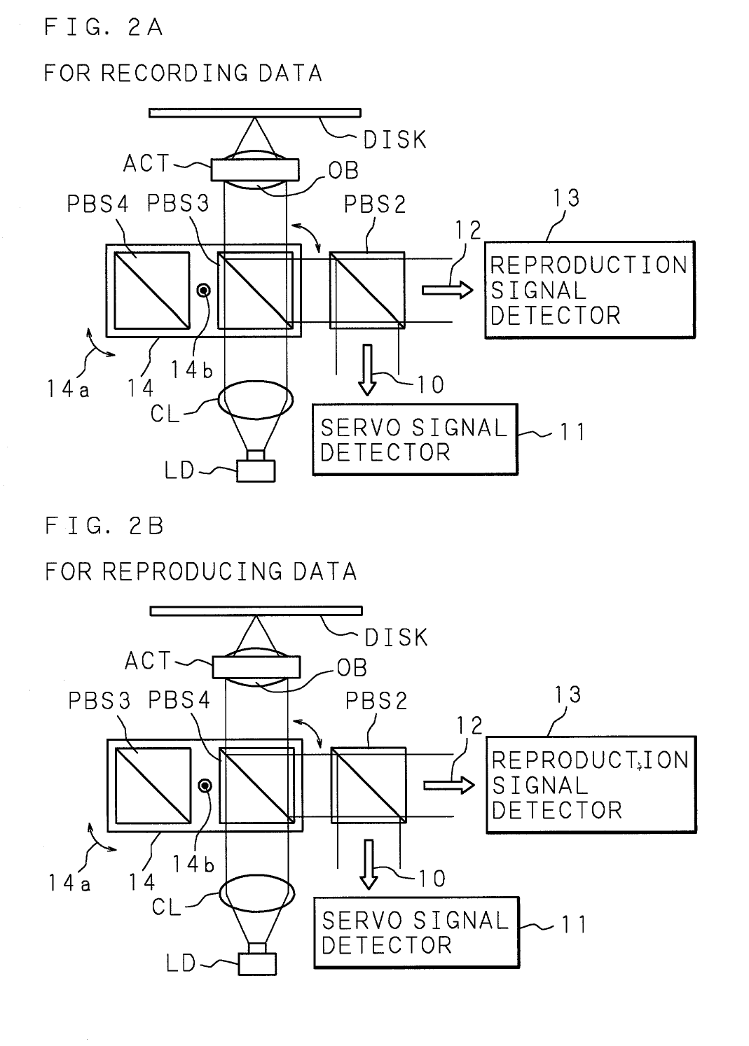

FIGS. 2A and 2B are block diagrams showing a main part of a magneto-optical recording and reproducing apparatus according to Embodiment 1 of the present invention. Operations of the laser source LD, a collimator lens CL, an actuator ACT, an objective lens OB, a magneto-optical recording medium DISK, a servo signal reflected beam 10, a servo signal detector 11, a reproduction signal reflected beam 12 and a reproduction signal detector 13 are the same as those of the conventional magneto-optical recording and reproducing apparatus (see FIG. 1) and detailed explanation thereof is omitted. The magneto-optical recording and reproducing apparatus according to Embodiment 1 further comprises a signal separating PBS 2, a polarization beam splitter for recording data (hereinafter referred to as “a recording PBS”) 3 and a polarization beam splitter for reproducing data (hereinafter referred to as “a reproducing PBS”) 4. The recording PBS 3 and the reproducing PBS 4 are disposed on a common PBS holder 14, which serves as a beam splitter displacing unit, so as to be parallel to each other. The recording PBS 3 and the reproducing PBS 4 are arranged in a rotation-symmetrical manner with a holder rotation axis 14b provided at the PBS holder 14 as a symmetry center, so as to be rotated in a rotational direction indicated by an arrow 14a within an angle of 180°. The rotational displacement of 180° of the recording PBS 3 and the reproducing PBS 4 is achieved with a simple mechanism such that, for example, the PBS holder 14 is rotated by a DC motor, which is not shown in the figures, to be brought into contact with a stopper, which is also not shown in the figures. With a magneto-optical recording and reproducing apparatus having such a structure, the positions of the recording PBS 3 and the reproducing PBS 4 can be changed with each other easily and reliably.

FIG. 2A shows a condition of the magneto-optical recording and reproducing apparatus at the time of data recording. For recording data, an optical path for recording data is formed by the laser source LD, the collimator lens CL, the recording PBS 3 and the objective lens OB. A laser beam is guided onto the magneto-optical recording medium DISK to record data. For focusing and tracking the magneto-optical recording medium DISK, a beam reflected at the magneto-optical recording medium DISK is guided to the servo signal detector 11 as a servo signal reflected beam 10, through the recording PBS 3 and the signal separating PBS 2.

FIG. 2B shows a condition of the magneto-optical recording and reproducing apparatus at the time of data reproducing. For reproducing data, the reproducing PBS 4 is rotationally displaced to the position where the recording PBS 3 is set at the time of data recording. As a result, an optical path for reproducing data is formed by the laser source LD, the collimator lens CL, the reproducing PBS 4, the objective lens OB, the magneto-optical recording medium DISK, the objective lens OB, the reproducing PBS 4 and the signal separating PBS 2. Abeam reflected at the magneto-optical recording medium DISK is guided to the signal separating PBS 2 through the reproducing PBS 4 to reproduce data. The guided beam is separated into the servo signal reflected beam 10 and the reproduction signal reflected beam 12 by the signal separating PBS 2. The servo signal reflected beam 10 and the reproduction signal reflected beam 12 are respectively received by the servo signal detector 11 and the reproduction signal detector 13. The servo signal reflected beam 10 is detected by the servo signal detector 11. The reproduction signal reflected beam 12 is detected by the reproduction signal detector 13. The action of the servo signal reflected beam 10 and the servo signal detector 11 is the same as that for recording data.

Now, regarding the conventional magneto-optical recording and reproducing apparatus (hereinafter referred to as “a conventional apparatus”), it is assumed that the P polarization transmittance Tp of the PBS 1 is 50% (=0.5) and the P polarization transmittance Tp of the signal separating PBS 2 is 50% (=0.5). These values will be also used in Embodiments 2 through 5 as reference values. Regarding the magneto-optical recording and reproducing apparatus of Embodiment 1 (hereinafter referred to as “an Embodiment 1”), it is assumed that the P polarization transmittance Tp of the recording PBS 3 is 75% (=0.75) and the P polarization transmittance Tp of the reproducing PBS 4 is 25% (=0.25). Based on the assumption, at the time of data recording, the ratio of the optical path efficiency of a laser beam to the medium of the Embodiment 1 to that of the conventional apparatus is 0.75/0.5=1.5 (times). When the quantity of light at the light-condensed points of the Embodiment 1 is set equal to that of the conventional apparatus, the quantity of light emitted from the laser source LD for recording data can be reduced with the Embodiment 1, in comparison with the conventional apparatus. Consequently, with the Embodiment 1, the power consumption of the laser source can be lowered and the life of the laser source can be elongated.

For reproducing data, it is assumed that the beam reflected at the light-condensed point of the magneto-optical recording medium DISK, i.e. the beam transmitted through the objective lens OB, of the Embodiment 1 is equal to that of the conventional apparatus. Based on the assumption, the ratio of the quantity of light received at the reproduction signal detector 13 of the Embodiment 1 to that of the conventional apparatus is ((1−0.25)*0.5)/((1−0.5)* 0.5)=1.5 (times). Since the quantity of light received in the Embodiment 1 is increased in comparison with the conventional apparatus, the carrier output C corresponding to the reproduction signal reflected beam 12 also increases. As a result, the carrier-output/noise ratio C/N can be increased.

Now, for example, it is assumed that the ratio of the sum of the medium noise Nd, the light source noise Nld and the shot noise Ns(Nd+Nld+Ns) to the circuit noise Nc is 1, as a prerequisite condition. This prerequisite condition will be also applied to Embodiments 2 through 5. The increase of the carrier-output/noise ratio C/N can be expressed by the following equation:

$$\text{INCREASE RATE OF} \text{C} = \sqrt{\frac{1 - 0.25}{1 - 0.5} \cdot \frac{0.5}{0.5}} = 1.225$$

$$\begin{matrix}\text{INCREASE RATE OF} N = \sqrt{\frac{{1}^{2} + {( 1 \times \sqrt{\frac{1 - 0.25}{1 - 0.5} \cdot \frac{0.5}{0.5}} )}^{2}}{{1}^{2} + {1}^{2}}} \\ = 1.118\end{matrix}$$

$$\begin{matrix}\text{INCREASE OF} C \text{/} N = 20 log \frac{\text{INCREASE RATE OF} C}{\text{INCREASE RATE OF} N} \\ = + 0.8 dB\end{matrix}$$

The above equation indicates that, with the Embodiment 1, the carrier-output/noise ratio C/N can be increased by 0.8 dB in comparison with the conventional apparatus.

Embodiment 2

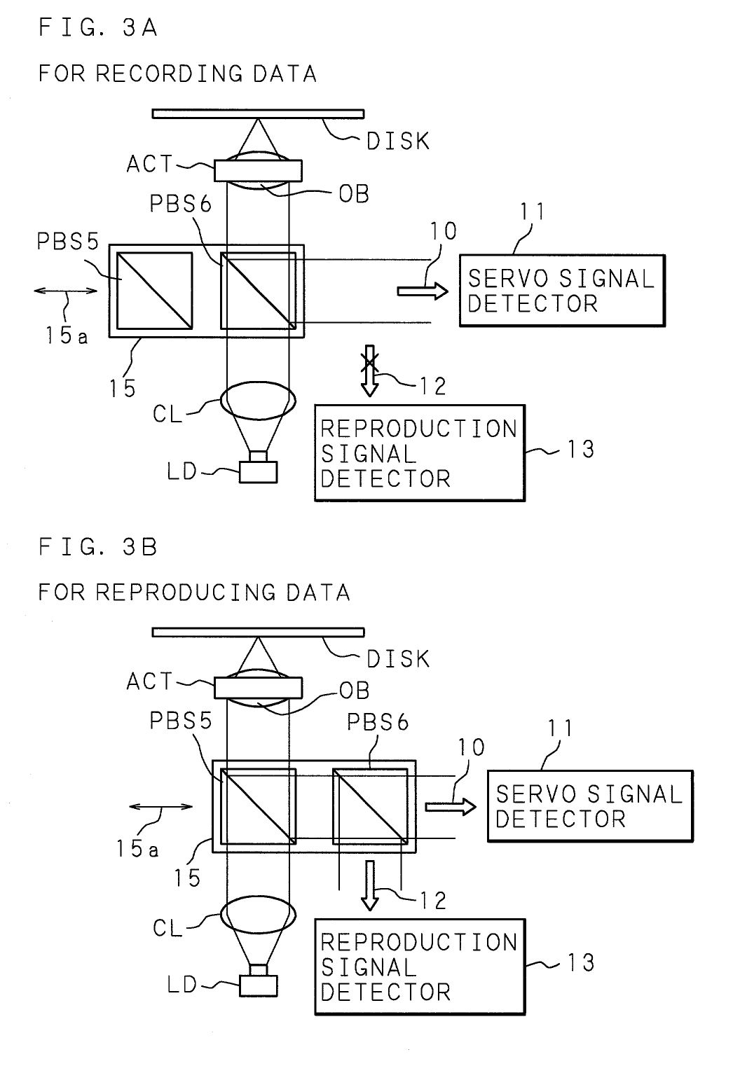

FIGS. 3A and 3B are block diagrams showing a main part of a magneto-optical recording and reproducing apparatus according to Embodiment 2 of the present invention. Like marks are used to refer to like parts of FIGS. 2A and 2B and detailed explanation thereof is omitted. A reproducing PBS 5 and a recording PBS 6 are disposed on a common PBS holder 15, which serves as a beam splitter displacing unit, so as to be parallel to each other. The reproducing PBS 5 and the recording PBS 6 can be displaced in parallel in a direction (indicated with an arrow 15a) perpendicular to the optical path of the laser beam which is formed by the collimator lens CL and the objective lens OB. For recording data, the recording PBS 6 is displaced in parallel up to a position on the optical path of the laser beam formed by the collimator lens CL and the objective lens OB. For reproducing data, the reproducing PBS 5 is displaced in parallel up to a position on the optical path of the laser beam. The parallel displacement of the reproducing PBS 5 and the recording PBS 6 is achieved with a simple structure such as a combination of a DC motor and a rack-and-pinion which are not shown in the figures. With a magneto-optical recording and reproducing apparatus having such a structure, the positions of the recording PBS 6 and the reproducing PBS 5 can be changed easily and reliably. The displacing unit of the PBS holder 15 is not limited to the DC motor, and may be a voice coil motor and the like.

FIG. 3A shows a condition of the magneto-optical recording and reproducing apparatus at the time of data recording. For recording data, a beam reflected at the magneto-optical recording medium DISK is reflected at the recording PBS 6 and guided to the servo signal detector 11 as a servo signal reflected beam 10. Although no reproduction signal reflected beam 12 is guided to the reproduction signal detector 13 here, there arises no practical problem since recording data and reproducing data are never executed simultaneously.

FIG. 3B shows a condition of the magneto-optical recording and reproducing apparatus at the time of data reproducing. For reproducing data, the reproducing PBS 5 is displaced in parallel to the position where the recording PBS 6 is set at the time of data recording. As a result, a beam reflected at the magneto-optical recording medium DISK is reflected at the reproducing PBS 5 and guided to the recording PBS 6. The recording PBS 6 acts as a polarization beam splitter for separating signals, i.e., the beam reflected at the magneto-optical recording medium DISK and guided to the recording PBS 6 is separated into the servo signal reflected beam 10 and the reproduction signal reflected beam 12. The servo signal reflected beam 10 and the reproduction signal reflected beam 12 are respectively guided to the servo signal detector 11 and the reproduction signal detector 13.

Now, regarding the magneto-optical recording and reproducing apparatus of Embodiment 2 (hereinafter referred to as “an Embodiment 2”), it is assumed that the P polarization transmittance Tp of the reproducing PBS 5 is 25% (=0.25) and the P polarization transmittance Tp of the recording PBS 6 is 60% (=0.6). Based on the assumption, at the time of data recording, the ratio of the optical path efficiency of a laser beam to the medium of the Embodiment 2 to that of the conventional apparatus is 0.6/0.5=1.2 (times). When the quantity of light at the light-condensed points of the Embodiment 2 is set equal to that of the conventional apparatus, the quantity of light emitted from the laser source LD for recording data can be reduced with the Embodiment 2 in comparison with the conventional apparatus, similarly to the Embodiment 1.

For reproducing data, it is assumed that the beam reflected at the light-condensed point, i.e. the beam transmitted through the objective lens OB, of the Embodiment 2 is equal to that of the conventional apparatus. Based on the assumption, the ratio of the quantity of light received at the reproduction signal detector 13 of the Embodiment 2 to that of the conventional apparatus is ((1−0.25)*(1−0.6))/((1−0.5)*0.5)=1.2 (times). Since the quantity of light received in the Embodiment 2 is increased in comparison with the conventional apparatus, the carrier output C corresponding to the reproduction signal reflected beam 12 also increases. As a result, the carrier-output/noise ratio C/N can be increased.

Similarly to the Embodiment 1, the increase of the carrier-output/noise ratio C/N can be expressed by the following equation:

$$\text{INCREASE RATE OF} \text{C} = \sqrt{\frac{1 - 0.25}{1 - 0.5} \cdot \frac{1 - 0.6}{0.5}} = 1.095$$

$$\begin{matrix}\text{INCREASE RATE OF} N = \sqrt{\frac{{1}^{2} + {( 1 \times \sqrt{\frac{1 - 0.25}{1 - 0.5} \cdot \frac{1 - 0.6}{0.5}} )}^{2}}{{1}^{2} + {1}^{2}}} \\ = 1.049\end{matrix}$$

$$\begin{matrix}\text{INCREASE OF} C \text{/} N = 20 log \frac{\text{INCREASE RATE OF} C}{\text{INCREASE RATE OF} N} \\ = + 0.4 dB\end{matrix}$$

The above equation indicates that, with the Embodiment 2 , the carrier-output/noise ratio C/N can be increased by 0.4 dB in comparison with the conventional apparatus.

Embodiment 3

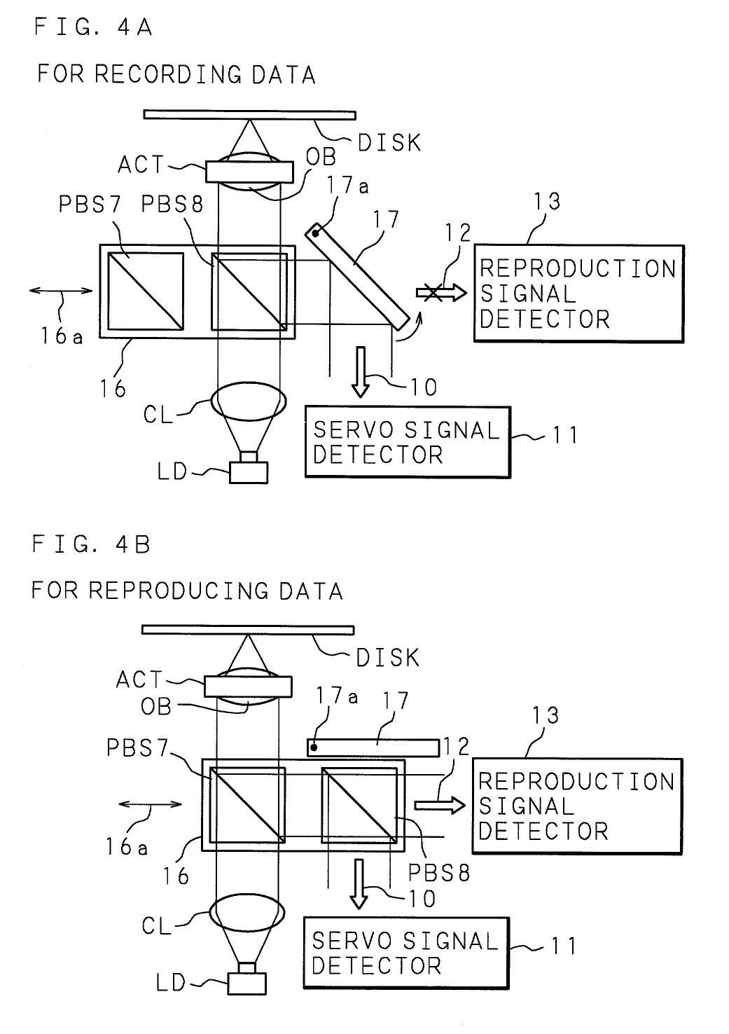

FIGS. 4A and 4B are block diagrams showing a main part of a magneto-optical recording and reproducing apparatus according to Embodiment 3 of the present invention. Like marks are used to refer to like parts of FIGS. 2A and 2B and detailed explanation thereof is omitted. A reproducing PBS 7 and a recording PBS 8 are, similarly to the Embodiment 2, disposed on a common PBS holder 16, which serves as a beam splitter displacing unit, so as to be parallel to each other. The reproducing PBS 7 and the recording PBS 8 can be displaced in parallel in a direction (indicated with an arrow 16a) perpendicular to the optical path of the laser beam which is formed by the collimator lens CL and the objective lens OB. For recording data, the recording PBS 8 is displaced in parallel up to a position on the optical path of the laser beam formed by the collimator lens CL and the objective lens OB. For reproducing data, the reproducing PBS 7 is displaced in parallel up to a position on the optical path of the laser beam. A reflecting mirror 17, which is constructed to be rotatable with a reflecting mirror rotation axis 17a, is disposed between the recording PBS 8 and the servo signal detector 11. The reflecting mirror 17 bends the optical path of the reflected beam guided by the recording PBS 8 by 90°. The reflected beam, the beam path of which was bent, is guided to the servo signal detector 11 as a servo signal reflected beam 10. With a magneto-optical recording and reproducing apparatus having a simple structure such as a PBS holder 16 which can be displaced in parallel, the positions of the recording PBS 7 and the reproducing PBS 8 can be changed easily and reliably.

FIG. 4A shows a condition of the magneto-optical recording and reproducing apparatus at the time of data recording. For recording data, a beam reflected at the magneto-optical recording medium DISK is guided to the reflecting mirror 17 by the recording PBS 8, and then, reflected at the reflecting mirror 17 in a direction perpendicular to the beam path thereof. The beam reflected at the reflecting mirror 17 is guided to the servo signal detector 11 as a servo signal reflected beam 10. Although no reproduction signal reflected beam 12 is guided to the reproduction signal detector 13 here since the reflecting mirror 17 performs a total reflection, there arises no practical problem since recording data and reproducing data are never executed simultaneously.

FIG. 4B shows a condition of the magneto-optical recording and reproducing apparatus at the time of data reproducing. For reproducing data, the reproducing PBS 7 is displaced in parallel to the position where the recording PBS 8 is set at the time of data recording. As a result, a beam reflected at the magneto-optical recording medium DISK is reflected at the reproducing PBS 7 and guided to the recording PBS 8. The recording PBS 8 acts as a polarization beam splitter for separating signals, and the beam reflected at the recording PBS 7 is separated into the servo signal reflected beam 10 and the reproduction signal reflected beam 12. The servo signal reflected beam 10 and the reproduction signal reflected beam 12 are respectively guided to the servo signal detector 11 and the reproduction signal detector 13. At the time of data reproducing, the reflecting mirror 17 is removed from the optical path by rotational displacement with the reflecting mirror rotation axis 17a.

Disposing the reflecting mirror 17, the positions of the servo signal detector 11 and the reproduction signal detector 13 can be reversed with regard to the Embodiment 2. Consequently, a high degree of freedom can be ensured in designing the configuration of the servo signal detector 11 and the reproduction signal detector 13.

Moreover, in the Embodiment 2 in which the reproduction signal reflected beam 12 is the reflected component of the recording PBS 6, the optical path efficiency of a beam to the medium at the time of data recording can not be excessively raised in consideration of a reproduction characteristic. However, in the Embodiment 3 in which the reproduction signal reflected beam 12 is a beam transmitted through the recording PBS 8, the efficiency at the time of data recording can be large, and therefore, the reproduction characteristic can be also enhanced.

Now, regarding the magneto-optical recording and reproducing apparatus of Embodiment 3 (hereinafter referred to as “an Embodiment 3”), it is assumed that the P polarization transmittance Tp of the reproducing PBS 7 is 25% (=0.25) and the P polarization transmittance Tp of the recording PBS 8 is 75% (=0.75). Based on the assumption, at the time of data recording, the ratio of the optical path efficiency of a laser beam to the medium of the Embodiment 3 to that of the conventional apparatus is 0.75/0.5=1.5 (times). When the quantity of light at the light-condensed points of the Embodiment 3 is set equal to that of the conventional apparatus, the quantity of light emitted from the laser source LD for recording data can be reduced with the Embodiment 3 in comparison with the conventional apparatus, similarly to the Embodiments 1 and 2.

For reproducing data, it is assumed that the beam reflected at the light-condensed point, i.e. the beam transmitted through the objective lens OB, of the Embodiment 3 is equal to that of the conventional apparatus. Based on the assumption, the ratio of the quantity of light received at the reproduction signal detector 13 of the Embodiment 3 to that of the conventional apparatus is ((1−0.25)*0.75)/((1−0.5)*0.5)=2.25 (times). Since the quantity of light received in the Embodiment 3 is increased in comparison with the conventional apparatus, the carrier output C corresponding to the reproduction signal reflected beam 12 also increases. As a result, the carrier-output/noise ratio C/N can be increased.

Similarly to the Embodiment 1, the increase of the carrier-output/noise ratio C/N can be expressed by the following equation:

$$\text{INCREASE RATE OF} \text{C} = \sqrt{\frac{1 - 0.25}{1 - 0.5} \cdot \frac{0.75}{0.5}} = 1.5$$

$$\begin{matrix}\text{INCREASE RATE OF} N = \sqrt{\frac{{1}^{2} + {( 1 \times \sqrt{\frac{1 - 0.25}{1 - 0.5} \cdot \frac{0.75}{0.5}} )}^{2}}{{1}^{2} + {1}^{2}}} \\ = 1.275\end{matrix}$$

$$\begin{matrix}\text{INCREASE OF} C \text{/} N = 20 log \frac{\text{INCREASE RATE OF} C}{\text{INCREASE RATE OF} N} \\ = + 1.4 dB\end{matrix}$$

The above equation indicates that, with the Embodiment 3, the carrier-output/noise ratio C/N can be increased by 1.4 dB in comparison with the conventional apparatus.

Embodiment 4

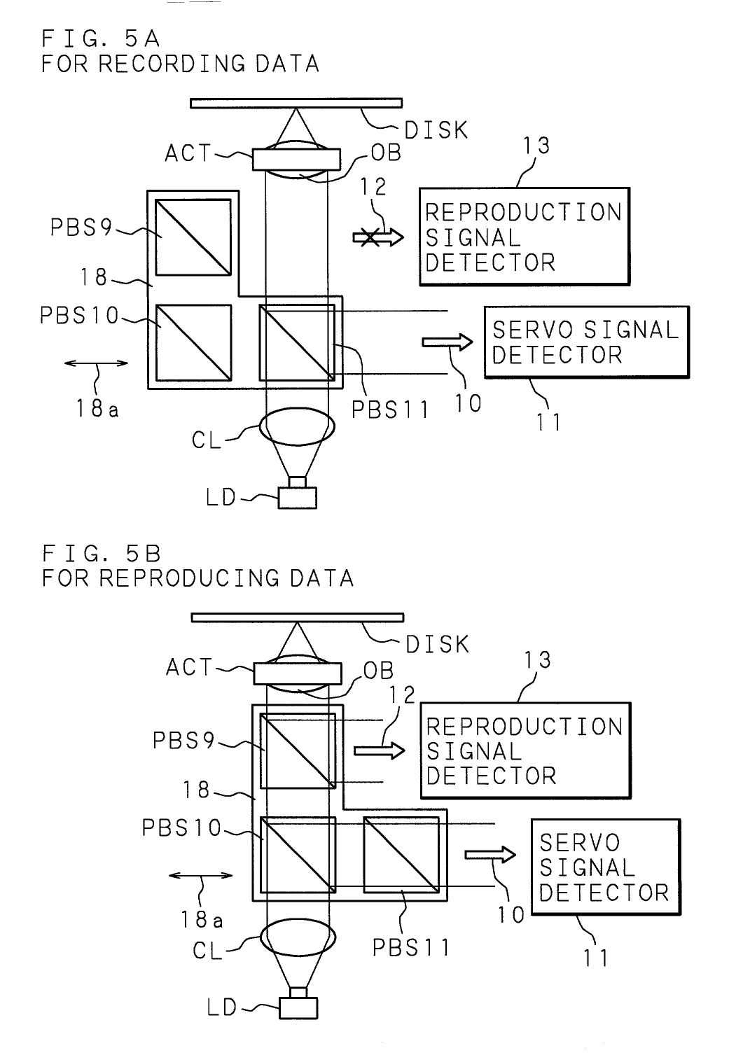

FIGS. 5A and 5B are block diagrams showing a main part of a magneto-optical recording and reproducing apparatus according to Embodiment 4 of the present invention. Like marks are used to refer to like parts of FIGS. 2A and 2B and detailed explanation thereof is omitted. A reproducing PBS 9, a polarization beam splitter for reflecting a beam (hereinafter referred to as “a reflecting PBS”) 10 and a recording PBS 11 are disposed on a common L-shaped PBS holder 18, which serves as a beam splitter displacing unit, so as to be parallel to each other. The PBS holder 18 can be displaced in parallel in a direction (indicated with an arrow 18a) perpendicular to the optical path of the laser beam which is formed by the collimator lens CL and the objective lens OB. For recording data, the recording PBS 11 is displaced in parallel up to a position on the optical path of the laser beam formed by the collimator lens CL and the objective lens OB. For reproducing data, the reproducing PBS 9 and the reflecting PBS 10 are displaced in parallel up to a position on the optical path of the laser beam. With the magneto-optical recording and reproducing apparatus having a simple structure such as the PBS holder 18 which can be displaced in parallel, the positions of the recording PBS 11 and the reproducing PBS 9 can be changed easily and reliably.

FIG. 5A shows a condition of the magneto-optical recording and reproducing apparatus at the time of data recording. For recording data, a beam reflected at the magneto-optical recording medium DISK is reflected at the recording PBS 11 and guided to the servo signal detector 11 as a servo signal reflected beam 10. Although no reproduction signal reflected beam 12 is guided to the reproduction signal detector 13, there arises no practical problem since recording data and reproducing data are never executed simultaneously.

FIG. 5B shows a condition of the magneto-optical recording and reproducing apparatus at the time of data reproducing. For reproducing data, the reflecting PBS 10 is disposed at the position where the recording PBS 11 is set at the time of data recording. The reproducing PBS 9 is disposed between the objective lens OB and the reflecting PBS 10. A beam reflected at the magneto-optical recording medium DISK is, on one hand, reflected at the reproducing PBS 9 and guided to the reproduction signal detector 13 as a reproduction signal reflected beam 12. On the other hand, the beam reflected at the magneto-optical recording medium DISK is also guided to the servo signal detector 11 through the reproducing PBS 9 and the recording PBS 11. At the time of data reproducing, disposed between the reproducing PBS 9 and the recording PBS 11 is the reflecting PBS 10 for reflecting and guiding the beam reflected at the magneto-optical recording medium DISK and transmitted through the reproducing PBS 9 to the recording PBS 11. The reflection by the reflecting PBS 10 allows the optical path of the reflected beam to be bent by 90° along the L-shaped vertical and horizontal lines of the PBS holder 18.

Now, regarding the magneto-optical recording and reproducing apparatus of Embodiment 4 (hereinafter referred to as “an Embodiment 4”), it is assumed that the P polarization transmittance Tp of the reproducing PBS 9 is 50% (=0.5), the P polarization transmittance Tp of the reflecting PBS 10 is 50% (=0.5) and the P polarization transmittance Tp of the recording PBS 11 is 75% (=0.75). Based on the assumption, at the time of data recording, the ratio of the optical path efficiency of a laser beam to the medium of the Embodiment 4 to that of the conventional apparatus is 0.75/0.5=1.5 (times). When the quantity of light at the light-condensed points of the Embodiment 4 is set equal to that of the conventional apparatus, the quantity of light emitted from the laser source LD for recording data can be reduced with the Embodiment 4 in comparison with the conventional apparatus, similarly to the Embodiments 1 through 3.

For reproducing data, it is assumed that the beam reflected at the light-condensed point, i.e. the beam transmitted through the objective lens OB, of the Embodiment 4 is equal to that of the conventional apparatus. Based on the assumption, the ratio of the quantity of light received at the reproduction signal detector 13 of the Embodiment 4 to that of the conventional apparatus is (1−0.5)/((1−0.5)*0.5)=2 (times). Since the quantity of light received in the Embodiment 4 is increased in comparison with the conventional apparatus, the carrier output C corresponding to the reproduction signal reflected beam 12 also increases. As a result, the carrier-output/noise ratio C/N can be increased.

Similarly to the Embodiment 1, the increase of the carrier-output/noise ratio C/N can be expressed by the following equation:

$$\text{INCREASE RATE OF} \text{C} = \sqrt{\frac{1 - 0.5}{1 - 0.5} \cdot \frac{1}{0.5}} = 1.414$$

$$\begin{matrix}\text{INCREASE RATE OF} N = \sqrt{\frac{{1}^{2} + {( 1 \times \sqrt{\frac{1 - 0.5}{1 - 0.5} \cdot \frac{1}{0.5}} )}^{2}}{{1}^{2} + {1}^{2}}} \\ = 1.225\end{matrix}$$

$$\begin{matrix}\text{INCREASE OF} C \text{/} N = 20 log \frac{\text{INCREASE RATE OF} C}{\text{INCREASE RATE OF} N} \\ = + 1.2 dB\end{matrix}$$

The above equation indicates that, with the Embodiment 4, the carrier-output/noise ratio C/N can be increased by 1.2 dB in comparison with the conventional apparatus.

Embodiment 5

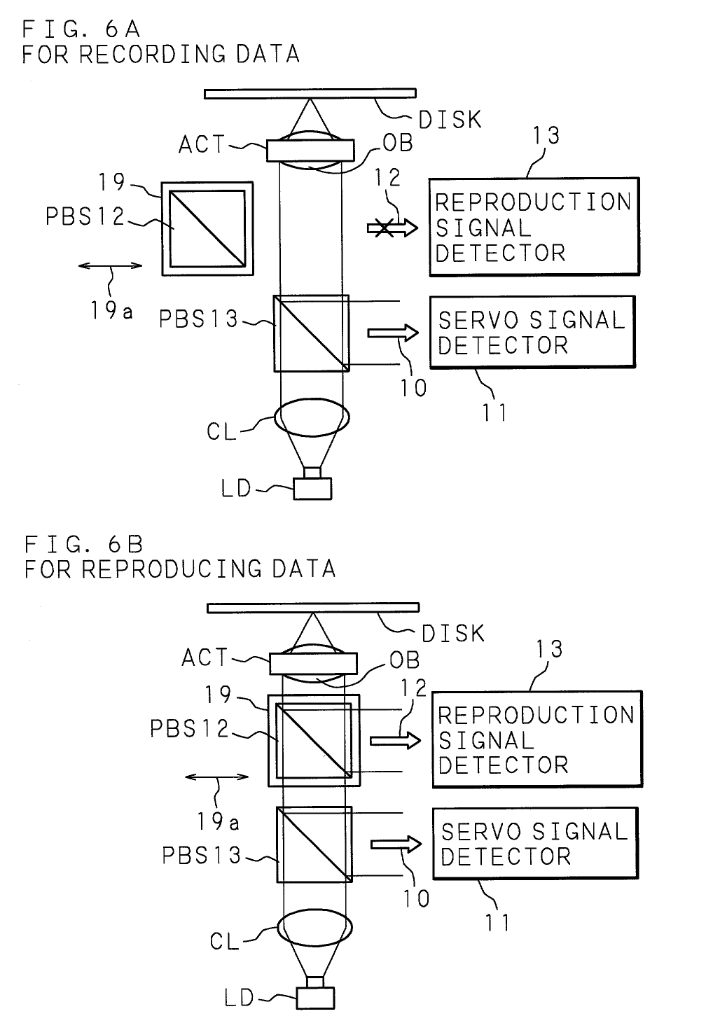

FIGS. 6A and 6B are block diagrams showing a main part of a magneto-optical recording and reproducing apparatus according to Embodiment 5 of the present invention. Like marks are used to refer to like parts of FIGS. 2A and 2B and detailed explanation thereof is omitted. A reproducing PBS 12 is disposed on a PBS holder 19 which serves as a beam splitter displacing unit. The PBS holder 19 can be displaced in parallel in a direction (indicated with an arrow 19a) perpendicular to the optical path of the laser beam which is formed by the collimator lens CL and the objective lens OB. The recording PBS 13 is fixed on the optical path of the laser beam formed by the collimator lens CL and the objective lens OB. With the magneto-optical recording and reproducing apparatus having a simple structure such as the PBS holder 19 which can be displaced in parallel, the position of the reproducing PBS 12 can be changed easily and reliably.

FIG. 6A shows a condition of the magneto-optical recording and reproducing apparatus at the time of data recording. For recording data, a beam reflected at the magneto-optical recording medium DISK is reflected at the recording PBS 13 and guided to the servo signal detector 11 as a servo signal reflected beam 10. The reproducing PBS 12 is removed from the optical path of the laser beam formed by the collimator lens CL and the objective lens OB. Although no reproduction signal reflected beam 12 is guided to the reproduction signal detector 13, there arises no practical problem since recording data and reproducing data are never executed simultaneously.

FIG. 6B shows a condition of the magneto-optical recording and reproducing apparatus at the time of data reproducing. For reproducing data, the reproducing PBS 12 is displaced in parallel up to a position on the optical path between the recording PBS 13 and the objective lens OB. A beam reflected at the magneto-optical recording medium DISK is, on one hand, reflected at the reproducing PBS 12 and guided to the reproduction signal detector 13 as a reproduction signal reflected beam 12. On the other hand, the beam reflected at the magneto-optical recording medium DISK is also guided to the recording PBS 13 through the reproducing PBS 12. The recording PBS 13 guides the servo signal reflected beam 10 to the servo signal detector 11.

Now, regarding the magneto-optical recording and reproducing apparatus of Embodiment 5 (hereinafter referred to as “an Embodiment 5”), it is assumed that the P polarization transmittance Tp of the reproducing PBS 12 is 33% (=0.33) and the P polarization transmittance Tp of the recording PBS 13 is 75% (=0.75). Based on the assumption, at the time of data recording, the ratio of the optical path efficiency of a laser beam to the medium of the Embodiment 5 to that of the conventional apparatus is 0.75/0.5=1.5 (times). When the quantity of light at the light-condensed points of the Embodiment 5 is set equal to that of the conventional apparatus, the quantity of light emitted from the laser source LD for recording data can be reduced with the Embodiment 5 in comparison with the conventional apparatus, similarly to the Embodiments 1 through 4.

For reproducing data, it is assumed that the beam reflected at the light-condensed point, i.e. the beam transmitted through the objective lens OB, of the Embodiment 5 is equal to that of the conventional apparatus. Based on the assumption, the ratio of the quantity of light received at the reproduction signal detector 13 of the Embodiment 5 to that of the conventional apparatus is (1−0.33)/((1−0.5)*0.5)=2.68 (times). Since the quantity of light received in the Embodiment 5 is increased in comparison with the conventional apparatus, the carrier output C corresponding to the reproduction signal reflected beam 12 also increases. As a result, the carrier-output/noise ratio C/N can be increased.

Similarly to the Embodiment 1, the increase of the carrier-output/noise ratio C/N can be expressed by the following equation:

$$\text{INCREASE RATE OF} \text{C} = \sqrt{\frac{1 - 0.33}{1 - 0.5} \cdot \frac{1}{0.5}} = 1.637$$

$$\begin{matrix}\text{INCREASE RATE OF} N = \sqrt{\frac{{1}^{2} + {( 1 \times \sqrt{\frac{1 - 0.33}{1 - 0.5} \cdot \frac{1}{0.5}} )}^{2}}{{1}^{2} + {1}^{2}}} \\ = 1.356\end{matrix}$$

$$\begin{matrix}\text{INCREASE OF} C \text{/} N = 20 log \frac{\text{INCREASE RATE OF} C}{\text{INCREASE RATE OF} N} \\ = + 1.6 dB\end{matrix}$$

The above equation indicates that, with the Embodiment 5, the carrier-output/noise ratio C/N can be increased by 1.6 dB in comparison with the conventional apparatus.

The invention will be more clearly understood with reference to the following example.

### EXAMPLE 1

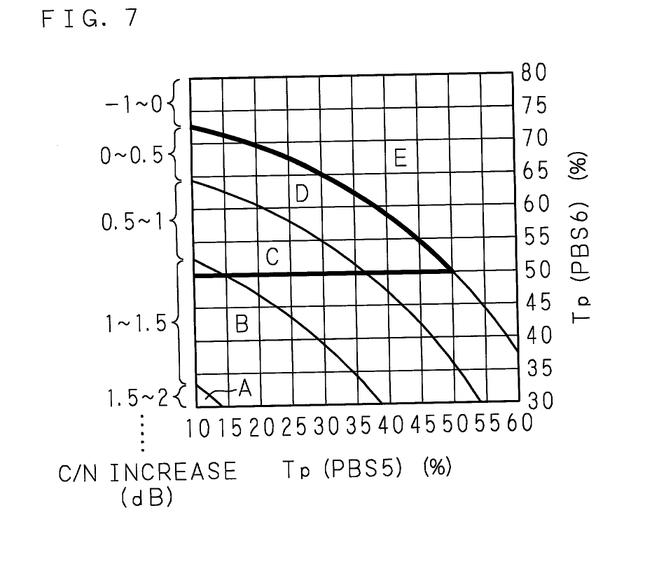

FIG. 7 is a graph showing an example where the transmittance of the polarization beam splitters of Embodiment 2 is changed. In the figure, Tp (PBS 5)(%) on the axis of abscissa indicates the P polarization transmittance of the reproducing PBS 5 and Tp (PBS 6)(%) on the axis of ordinate indicates the P polarization transmittance of the recording PBS 6. The increase of the carrier-output/noise ratio C/N obtained by a combination of the P polarization transmittance of the recording PBS 5 and the P polarization transmittance of the recording PBS 6 is shown in the figure as a parameter of C/N increase (dB). In the figure, A covers the area where the C/N increase is 1.5 to 2 times, B covers the area where the C/N increase is 1 to 1.5 times, C covers the area where the C/N increase is 0.5 to 1 times, D covers the area where the C/N increase is 0 to 0.5 times, and E covers the area where the C/N increase is −1 to 0 times. The reference and prerequisite condition in Embodiment 1 are also applied to the following explanation. Regarding an employable range of the P polarization transmittance, Tp (PBS 6) is required to be 50 or above since one of the objects of the present invention is to enhance the optical path efficiency of a beam to the medium at the time of data recording with regard to the conventional apparatus. Moreover, the C/N increase (dB) is required to be over 0. To meet the above requirements, the range is limited to the area enclosed with bold lines in the figure. Within the range enclosed with the bold lines, the C/N increase (dB) is approximately 0.5. A predetermined effect can be realized by selecting the P polarization transmittance of the reproducing PBS 5 and the P polarization transmittance of the recording PBS 6 suitably. The area enclosed with the bold lines in the figure can be expressed by the following general equation:

Tp(PBS 1)<Tp(PBS 6)<1−(1−Tp(PBS 1))*Tp(PBS 2)/(1−Tp(PBS 5))

where Tp(PBS 1) is the P polarization transmittance of the PBS 1, Tp(PBS 2) is the P polarization transmittance of the signal separating PBS 2, Tp(PBS 5) is the P polarization transmittance of the reproducing PBS 5 and Tp(PBS 6) is the P polarization transmittance of the recording PBS 6.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A magneto-optical recording and reproducing apparatus comprising:
a light source for generating a beam for irradiating a magneto-optical recording medium;
a reproduction signal detector for detecting a beam reflected at the magneto-optical recording medium as a reproduction signal;
a servo signal detector for detecting a beam reflected at the magneto-optical recording medium as a servo signal to be used for focusing and tracking of the beam;
a separating polarization beam splitter for separating a beam reflected at the magneto-optical recording medium into a reflected beam for detecting a reproduction signal and a reflected beam for detecting a servo signal;
a recording polarization beam splitter disposed on an optical path at time of data recording, for guiding a beam reflected at the magneto-optical recording medium to the separating polarization beam splitter;
a reproducing polarization beam splitter disposed on the optical path at time of data reproducing, for guiding a beam reflected at the magneto-optical recording medium to the separating polarization beam splitter; and
a beam splitter displacing unit for displacing the recording polarization beam splitter and the reproducing polarization beam splitter.

2. The magneto-optical recording and reproducing apparatus according to claim 1, wherein a transmittance of the recording polarization beam splitter is larger than a transmittance of the reproducing polarization beam splitter.

3. A magneto-optical recording and reproducing apparatus comprising:
a light source for generating a beam for irradiating a magneto-optical recording medium;
a reproduction signal detector for detecting a beam reflected at the magneto-optical recording medium as a reproduction signal;
a servo signal detector for detecting a beam reflected at the magneto-optical recording medium as a servo signal to be used for focusing and tracking of the beam;
a recording polarization beam splitter disposed on an optical path at time of data recording, for guiding a beam reflected at the magneto-optical recording medium as a reflected beam for detecting a servo signal;
a reproducing polarization beam splitter disposed on the optical path at time of data reproducing, for guiding a beam reflected at the magneto-optical recording medium to the recording polarization beam splitter; and
a beam splitter displacing unit for displacing the recording polarization beam splitter and the reproducing polarization beam splitter.

4. The magneto-optical recording and reproducing apparatus according to claim 3, wherein a transmittance of the recording polarization beam splitter is larger than a transmittance of the reproducing polarization beam splitter.

5. The magneto-optical recording and reproducing apparatus according to claim 3, further comprising a reflecting mirror for guiding the reflected beam guided from the recording polarization beam splitter to the servo signal detector as a reflected beam for detecting a servo signal at the time of data recording.

6. The magneto-optical recording and reproducing apparatus according to claim 5, wherein a transmittance of the recording polarization beam splitter is larger than a transmittance of the reproducing polarization beam splitter.

7. A magneto-optical recording and reproducing apparatus comprising:
a light source for generating a beam for irradiating a magneto-optical recording medium;
a reproduction signal detector for detecting a beam reflected at the magneto-optical recording medium as a reproduction signal;
a servo signal detector for detecting a beam reflected at the magneto-optical recording medium as a servo signal to be used for focusing and tracking of the beam;
a recording polarization beam splitter disposed on an optical path at time of data recording, for guiding a beam reflected at the magneto-optical recording medium as a reflected beam for detecting a servo signal;
a reproducing polarization beam splitter disposed on the optical path at time of data reproducing, for guiding a beam reflected at the magneto-optical recording medium as a reflected beam for detecting a reproduction signal;
a reflecting polarization beam splitter for guiding a beam reflected at the magneto-optical recording medium to the recording polarization beam splitter through the reproducing polarization beam splitter at the time of data reproducing; and
a beam splitter displacing unit for displacing the recording polarization beam splitter, the reproducing polarization beam splitter and the reflecting polarization beam splitter.

8. The magneto-optical recording and reproducing apparatus according to claim 7, wherein a transmittance of the recording polarization beam splitter is larger than a transmittance of the reproducing polarization beam splitter.

9. A magneto-optical recording and reproducing apparatus comprising:
a light source for generating a beam for irradiating a magneto-optical recording medium;
a reproduction signal detector for detecting a beam reflected at the magneto-optical recording medium as a reproduction signal;
a servo signal detector for detecting a beam reflected at the magneto-optical recording medium as a servo signal to be used for focusing and tracking of the beam;
a recording polarization beam splitter disposed on an optical path, for guiding a beam reflected at the magneto-optical recording medium as a reflected beam for detecting a servo signal;
a reproducing polarization beam splitter disposed on the optical path at time of data reproducing, for guiding a beam reflected at the magneto-optical recording medium as a reflected beam for detecting a reproduction signal; and
a beam splitter displacing unit for displacing the reproducing polarization beam splitter.

10. The magneto-optical recording and reproducing apparatus according to claim 9, wherein a transmittance of the recording polarization beam splitter is larger than a transmittance of the reproducing polarization beam splitter.

11. A magneto-optical recording and reproducing apparatus comprising:
a data recording polarization beam splitter for guiding a beam onto a magneto-optical recording medium at time of data recording;
a data reproducing polarization beam splitter for guiding a beam reflected at the magneto-optical recording medium to a reproduction signal detector at time of data reproducing;
a servo signal detector for detecting a beam reflected at the magneto-optical recording medium for focusing and tracking of the beam;
a signal separating polarization beam splitter for separately guiding a beam reflected at the magneto-optical recording medium to the reproduction signal detector and the servo signal detector,
wherein the data recording polarization beam splitter is, at the time of data recording, disposed so as to guide a beam reflected at the magneto-optical recording medium to the signal separating polarization beam splitter, and
the data reproducing polarization beam splitter is, at the time of data reproducing, disposed so as to guide a beam reflected at the magneto-optical recording medium to the signal separating polarization beam splitter.

12. The magneto-optical recording and reproducing apparatus according to claim 11, wherein a transmittance of the data recording polarization beam splitter is larger than a transmittance of the data reproducing polarization beam splitter.

13. A magneto-optical recording and reproducing apparatus comprising:
a data recording polarization beam splitter for guiding a beam onto a magneto-optical recording medium at time of data recording;
a data reproducing polarization beam splitter for guiding a beam reflected at the magneto-optical recording medium to a reproduction signal detector at time of data reproducing; and
a servo signal detector for detecting a beam reflected at the magneto-optical recording medium for focusing and tracking of the beam,
wherein the data recording polarization beam splitter is, at the time of data recording, disposed so as to guide a beam reflected at the magneto-optical recording medium to the servo signal detector, and
the data recording polarization beam splitter is, at the time of data reproducing, disposed so as to guide a beam reflected at the magneto-optical recording medium through the data reproducing polarization beam splitter,
whereby the guided beam reflected at the magneto-optical recording medium is separated and guided to the reproduction signal detector and the servo signal detector.

14. The magneto-optical recording and reproducing apparatus according to claim 13, wherein a transmittance of the data recording polarization beam splitter is larger than a transmittance of the data reproducing polarization beam splitter.

15. A magneto-optical recording and reproducing apparatus comprising:
a data recording polarization beam splitter for guiding a beam onto a magneto-optical recording medium at time of data recording;
a data reproducing polarization beam splitter for guiding a beam reflected at the magneto-optical recording medium to a reproduction signal detector at time of data reproducing; and
a servo signal detector for detecting a beam reflected at the magneto-optical recording medium for focusing and tracking of the beam,
wherein the data recording polarization beam splitter is, at the time of data recording, disposed so as to guide a beam reflected at the magneto-optical recording medium to the servo signal detector,
the data reproducing polarization beam splitter is, at the time of data reproducing, disposed so as to guide a beam reflected at the magneto-optical recording medium to the reproduction signal detector, and
the data recording polarization beam splitter is, at the time of data reproducing, disposed so as to receive a beam reflected at the magneto-optical recording medium through the data reproducing polarization beam splitter,
whereby the received beam reflected at the magneto-optical recording medium is guided to the servo signal detector.

16. The magneto-optical recording and reproducing apparatus according to claim 15, wherein a transmittance of the data recording polarization beam splitter is larger than a transmittance of the data reproducing polarization beam splitter.
